(19) United States
(12) Patent Application Publication
(10) Pub. No.: US 2026/0353290 A1
(43) Pub. Date: Nov. 5, 2026

(54) WAKE-UP SIGNAL PROCESSING METHOD AND APPARATUS, AND NETWORK DEVICE

(71) Applicant: SPREADTRUM COMMUNICATIONS (SHANGHAI) CO., LTD., Shanghai (CN)

(72) Inventors: Huayu ZHOU, Shanghai (CN); Zhengang PAN, Shanghai (CN)

(21) Appl. No.: 19/125,542

(22) PCT Filed: Nov. 3, 2023
(86) PCT No.: PCT/CN2023/129672

§ 371 Date: Apr. 29, 2025

(30) Foreign Application Priority Data
Nov. 4, 2022 (CN) 202211380605.9

(51) Int. Cl. H04W 52/02

(52) U.S. Cl. CPC H04W 52/0235

(57) ABSTRACT

A wake-up signal processing method and apparatus and a network device is provided. The method includes processing a first sequence to output a second sequence, where the length of the second sequence is greater than that of the first sequence.

### CROSS-REFERENCE TO RELATED APPLICATION(S)

This application is a National Stage of International Application No. PCT/CN2023/129672, field Nov. 3, 2023, which claims priority to Chinese Patent Application No. 202211380605.9 filed Nov. 4, 2022, the entire disclosures of both of which are hereby incorporated by reference.

### TECHNICAL FIELD

This disclosure relates to the field of communication technology, particularly to a wake-up signal processing method and apparatus, and a network device.

### BACKGROUND

To reduce the power consumption of terminal devices, a low power wake-up signal (LP-WUS) mechanism can be introduced.

In certain scenarios or moments, the terminal device can only activate a low power wake-up signal receiver (abbreviated as LP-WUS receiver, LP-WUR, or LR) that is independent of the main radio (MR). In this way, the terminal device can turn off the MR to achieve energy saving (reducing power consumption), while also being able to listen for LP-WUS through the LP-WUS receiver, waiting to be awakened by the network and achieving network reachability. By using the main radio and the LP-WUS receiver, both energy saving and network reachability can be addressed simultaneously.

The communication process in a communication system often needs to consider inter-cell interference, and the inter-cell interference randomization is very beneficial for the communication system. To achieve the purpose of the inter-cell interference randomization, it is usually necessary to ensure that the sequences (channels/signals) to be transmitted have a longer sequence length (such as having many bits in the sequence), and a longer sequence length leads to a lower correlation/association between various sequences (channels/signals), thus reducing the correlation/association to ensure inter-cell interference randomization as much as possible.

However, due to the short length of the wake-up signal sequence (e.g., the limited number of bits carried by the wake-up signal sequence), the transmission process of wake-up signals may fail to guarantee inter-cell interference randomization in scenarios with a large number of cell identities (IDs). Therefore, further research is needed on how to optimize the wake-up signal sequence to ensure inter-cell interference randomization.

### SUMMARY

In a first aspect, a wake-up signal processing method is provided in the present disclosure. The method includes processing a first sequence to output a second sequence.

In a second aspect, a wake-up signal processing method is provided in the present disclosure. The method includes: modulating a first sequence to output an eighth sequence; and pre-coding the eighth sequence to output a ninth sequence.

In a third aspect, a wake-up signal processing method is provided in the present disclosure. The method includes: processing a first sequence for a first time to output an eleventh sequence.

Reference of the beneficial effects brought by the technical solutions from the second aspect to the twelfth aspect can be made to the technical effects brought by the technical solutions in the first aspect, second aspect, or third aspect, which will not be repeated here.

### BRIEF DESCRIPTION OF THE DRAWINGS

In order to more clearly illustrate technical solutions in embodiments of the disclosure, the drawings needed for describing the embodiments or the related art will be briefly introduced below.

FIG. 1 is a schematic diagram of an architecture of a communication system in embodiments of the disclosure.

FIG. 2 is a flowchart of a wake-up signal processing method in embodiments of the disclosure.

FIG. 3 is a flowchart of another wake-up signal processing method in embodiments of the disclosure.

FIG. 4 is a flowchart of another wake-up signal processing method in the embodiments of the disclosure.

FIG. 5 is a functional block diagram of a wake-up signal processing apparatus in embodiments of the disclosure.

FIG. 6 is a functional block diagram of another wake-up signal processing apparatus in embodiments of the disclosure.

FIG. 7 is a functional block diagram of another wake-up signal processing apparatus in embodiments of the disclosure.

FIG. 8 is a schematic structural diagram of a network device in embodiments of the disclosure.

FIG. 9 is a schematic structural diagram of another network device in embodiments of the disclosure.

FIG. 10 is a schematic structural diagram of another network device in embodiments of the disclosure.

### DETAILED DESCRIPTION

It should be understood that, the terms “first”, “second”, and the like involved in embodiments of the disclosure are used to distinguish different objects, and are not necessarily used to describe a particular sequence or order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

The term “and/or” in embodiments of the disclosure describes an association relationship between associated objects, and indicates that there may be three relationships, for example, A and/or B may mean A alone, both A and B exist, and B alone. A and B each may be a singular from or a plural form.

In embodiments of the disclosure, the character “/” herein can indicate that the associated objects are in an “or” relationship. In addition, the symbol “/” may represent a divisor, i. e., perform a division operation. For example, A/B may mean A is divided by B.

The term “at least one (item) of” or the like in embodiments of the disclosure refers to any combination of these items, including any combination of a single item or multiple items, and refers to one or multiple items. For example, at least one (item) of a, b, or c can represent the following seven cases: a; b; c; a and b; a and c; b and c; a, b, and c. a, b, and c each may be an element or a set including one or more elements.

The term “equal to” in embodiments of the disclosure can be used in conjunction with “greater than” and applicable to the technical solution used in the case of “greater than”, or can be used in conjunction with “less than” and applicable to the technical solution used in the case of “less than”. When “equal to” is used in conjunction with “greater than”, “equal to” cannot be used in conjunction with “less than”; and when “equal to” is used in conjunction with “less than”, “equal to” cannot be used in conjunction with “greater than”.

The terms “of”, “corresponding/relevant”, and “indicated” in embodiments of the disclosure may sometimes be used interchangeably, and it may be noted that, when the difference therebetween is not emphasized, the meanings thereof are the same.

The “connection” in embodiments of the disclosure refers to various manners of connection, such as direct connection or indirect connection, so as to implement communication between devices, which is not limited herein.

The terms “network” and “system” in embodiments of the disclosure can be expressed as the same concept, and a communication system is a communication network.

Related contents, concepts, meanings, technical problems, technical solutions, advantages, and the like involved in embodiments of the disclosure are described below.

### I. COMMUNICATION SYSTEM, TERMINAL DEVICE, AND NETWORK DEVICE

### 1. Communication System

The technical solutions of embodiments of the disclosure may be applied to various communication systems, for example, a general packet radio service (GPRS), a long term evolution (LTE) system, an advanced long term evolution (LTE-A) system, a new radio (NR) system, an evolved system of the NR system, an LTE-based access to unlicensed spectrum (LTE-U) system, and an NR-based access to unlicensed spectrum (NR-U) system, a non-terrestrial network (NTN) system, a universal mobile telecommunication system (UMTS), a wireless local area networks (WLAN), a wireless fidelity (Wi-Fi), the 6^{th}-generation (6G) communication system, or other communication systems.

It may be noted that, a conventional communication system supports a limited number of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, vehicle to everything (V2X) communication, narrowband internet of things (NB-IoT) communication, etc. Embodiments of the disclosure can also be applied to these communication systems.

In addition, the technical solutions of embodiments of the disclosure may be applied to a beamforming scenario, a carrier aggregation (CA) scenario, a dual connectivity (DC) scenario, or a standalone (SA) network deployment scenario.

In embodiments of the disclosure, the spectrum used for communication between a terminal device and a network device, or the spectrum used for communication between terminal devices may be a licensed spectrum or an unlicensed spectrum, which is not limited herein. In addition, an unlicensed spectrum may be understood as a shared spectrum, and a licensed spectrum may be understood as a non-shared spectrum.

Since in embodiments of the disclosure, various embodiments are described with reference to a terminal device and a network device, the terminal device and the network device involved will be described in detail below.

### 2. Terminal Device

The terminal device may be a device having transceiver functions. The terminal device may also be referred to as a user equipment (UE), a remote UE, a relay UE, an access terminal device, a subscriber unit, a subscriber station, a mobile station, a remote station, a remote station, a mobile device, a user terminal device, a smart terminal device, a wireless communication device, a user agent, or a user apparatus. It may be noted that the relay UE is a terminal device that can provide relay forwarding service for other terminal devices (including a remote terminal device).

For example, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

For another example, the terminal device may be a cellular radio telephone, a cordless telephone, a session initiation protocol (SIP) telephone, a wireless local loop (WLL) station, a personal digital assistant (PDA), various devices with wireless communication functions such as a handheld device, a computing device, or other processing devices coupled with a wireless modem, an in-vehicle device, a wearable device, and a terminal device in a next-generation communication system, for example, a terminal device in an NR communication system or in a 6G communication system, or a terminal device in a future evolved public land mobile network (PLMN), etc., which is not specifically limited herein.

In some possible implementations, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In some possible implementations, the terminal device may include an apparatus with wireless communication functions, such as a system-on-chip (SOC), a chip, or a chip module. Exemplarily, the SOC may include a chip, and may further include other discrete components.

### 3. Network Device

The network device may be a device having transceiver function, and is configured to communicate with a terminal device.

In some possible implementations, the network device may be responsible for radio resource management (RRM), quality of service (QoS) management, data compression and encryption, data transmission and reception, etc. at an air-interface side.

In some possible implementations, the network device may be a base station (BS) in a communication system or a device which is deployed in a radio access network (RAN) and used for providing wireless communication functions.

For example, the network device may be an evolved node B (eNB or eNodeB) in an LTE communication system, a next-generation evolved node B (ng-eNB) in an NR communication system, a next-generation node B (gNB) in an NR communication system, a master node (MN) in a DC architecture, a second node or a secondary node (SN) in a DC architecture, and the like, which is not specifically limited herein.

In some possible implementations, the network device may also be a device in a core network (CN), such as an access and mobility management function (AMF), a user plane function (UPF), etc.; or may be an access point (AP) in a WLAN, a relay station, a communication device in a future evolved PLMN network, a communication device in an NTN network, and the like.

In some possible implementations, the network device may include an apparatus for providing wireless communication functions for the terminal device, such as an SOC, a chip, a chip module. For example, the SOC may include a chip, or may include other discrete devices.

In some possible implementations, the network device may communicate with an internet protocol (IP) network, for example, the internet, a private IP network, or other data network, etc.

In some possible implementations, the network device may be an independent node to implement the functions of the foregoing base station, or the network device may include two or more independent nodes to implement the functions of the foregoing base station. For example, the network device may a centralized unit (CU) and a DU, such as a gNB-CU and a gNB-DU. Further, in other embodiments of the disclosure, the network device may further include an active antenna unit (AAU). The CU implements some functions of the network device, and the DU implements some other functions of the network device. For example, the CU is responsible for processing non-real-time protocols and services, and implements functions of a radio resource control (RRC) layer, functions of a service data adaptation protocol (SDAP) layer, functions of a packet data convergence protocol (PDCP) layer. The DU is responsible for processing physical (PHY) layer protocols and real-time services, and implements functions of a radio link control (RLC) layer, functions of a medium access control (MAC) layer, and functions of a PHY layer. In addition, AAU can implement some PHY layer processing functions, radio frequency processing functions, and active-antenna related functions. Since RRC layer information will eventually become PHY layer information, or is transformed from PHY layer information, in this architecture, it may be considered that higher-layer signaling, such as RRC layer signaling, is generated by the CU and transmitted by the DU or transmitted by the DU and the AAU. It can be understood that, the network device may include at least one of the CU, the DU, or the AAU. In addition, the CU may be categorized as a network device in a RAN, or may be categorized as a network device in a CN, and the disclosure is not limited in this regard.

In some possible implementations, the network device may be any one of multiple stations that perform coherent joint transmission (CJT) with the terminal device, another station other than the multiple stations, or another network device for performing network communication with the terminal device, which is not limited herein. Multi-station coherent joint transmission may be joint coherent transmission of multiple stations, transmission of different data belonging to the same physical downlink shared channel (PDSCH) from different stations to the terminal device, or transmission by multiple stations virtualized into one station. Names with the same meaning specified in other standards are also applicable to the disclosure. That is, the names of these parameters are not limited in the disclosure. The station in multi-station coherent joint transmission may be a remote radio head (RRH), a transmission and reception point (TRP), a network device, etc., which is not limited herein.

In some possible implementations, the network device may be any one of multiple stations that perform incoherent joint transmission with the terminal device, another station other than the multiple stations, or another network device that performs network communication with the terminal device, which is not limited herein. Multi-station incoherent joint transmission may be joint incoherent transmission of multiple stations, transmission of different data belonging to the same PDSCH from different stations to the terminal device, or transmission of different data belonging to the same PDSCH from different stations to the terminal device. Names with the same meaning specified in other standards are also applicable to the disclosure. That is, the names of these parameters are not limited in the disclosure. The station in multi-station incoherent joint transmission may be a RAH, a TRP, a network device, etc., which is not limited herein.

In some possible implementations, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In some possible implementations, the network device may provide services for a cell. The terminal device in the cell can communicate with the network device through transmission resources, such as spectrum resources. The cell may be a macro cell, a small cell, a metro cell, a micro cell, a pico cell, a femto cell, etc.

### 4. Exemplary Illustration

The communication system in embodiments of the disclosure is exemplified below.

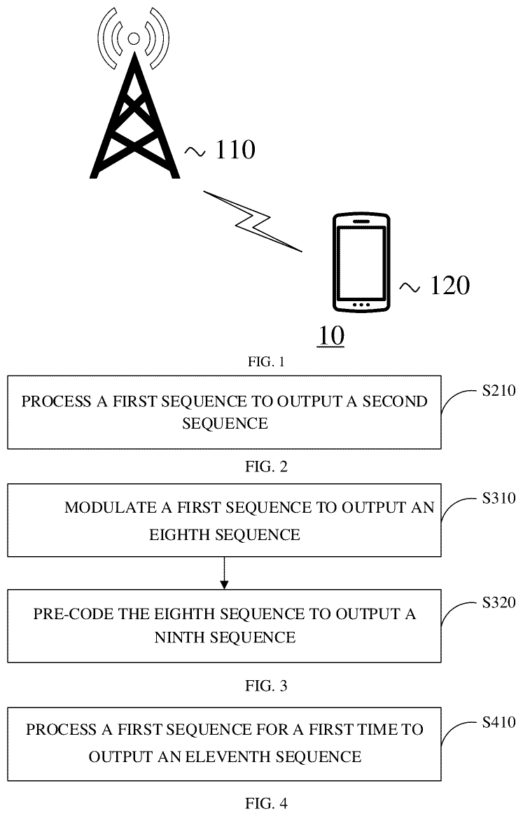

Exemplarily, referring to FIG. 1, a network architecture of a communication system in embodiments of the disclosure is illustrated. As illustrated in FIG. 1, the communication system 10 may include a network device 110 and a terminal device 120. The network device 110 can communicate with the terminal device 120.

FIG. 1 only illustrates an example of the network architecture of the communication system, and does not constitute a limitation on the network architecture of the communication system in embodiments of the disclosure. For example, in embodiments of the disclosure, the communication system 10 may further include a server or other devices. For another example, in embodiments of the disclosure, the communication system 10 may include multiple network devices and/or multiple terminal devices.

### II. MAIN RADIO

It may be noted that the main radio, also referred to as the main transceiver, overall transceiver, or regular transceiver, etc., has a complete radio frequency and baseband processing architecture. The main radio can be seen as a module for transmitting and receiving 5G NR signals/channels other than low power wake-up signals.

### 1. Paging Related Physical Downlink Control Channel (PDCCH)

In general, under the radio resource control idle state (RRC_IDLE state) or the radio resource control inactive state (RRC_INACTIVE state), the terminal device needs to monitor the paging related PDCCH, also known as type2-PDCCH. The radio network temporary identity (RNTI) for the paging related PDCCH is P-RNTI, and the downlink control information (DCI) format used is DCI format 1-0.

When the terminal device detects the paging related PDCCH (successfully decoding the cyclic redundancy check (CRC) using P-RNTI), the terminal device can parse the DCI. The DCI may contain short messages, enabling the terminal device to receive alert information or perform system information updates. Additionally, the DCI may also contain scheduling information, allowing the terminal device to receive the paging related physical downlink shared channel (PDSCH), thereby obtaining the paging message and further initiating the random access procedure to enter the connected state (RRC_CONNECTED state).

The functions of the paging message are as follows: (1) to send a call request to terminal devices in RRC_IDLE state; (2) to notify terminal devices in RRC_IDLE, RRC_INACTIVE, or RRC_CONNECTED state that system information has changed; and (3) to indicate terminal devices to start receiving primary notifications and/or secondary notifications from the earthquake and tsunami warning system (ETWS); to indicate terminal devices to start receiving notifications from the commercial mobile alert system (CMAS).

In addition, before obtaining the paging message, the terminal device needs to achieve time-frequency synchronization using reference signals (e.g., synchronization signal/physical broadcast channel block (SSB)) and complete the adjustment of automatic gain control (AGC).

The monitoring occasion for paging related PDCCH can be configured by the search space set (SSS).

Terminal devices in RRC_IDLE or RRC_INACTIVE state can use the discontinuous reception (DRX) mechanism to receive paging messages to reduce power consumption. A DRX cycle can contain at least one paging frame (PF).

A PF can be a radio frame or a system frame, and it may contain one or more paging occasions (PO) or a PO starting point.

The PO can be used to determine the starting point of the monitoring occasion within the PF, can indicate the time-domain location of the paging related PDCCH, can be used to transmit paging downlink control information (paging DCI), can be composed of multiple subframes, multiple timeslots, or multiple OFDM symbols, and can consist of multiple monitoring occasions for paging related PDCCH. The monitoring occasion for paging related PDCCH can also be referred to as a paging PDCCH monitoring occasion (PMO). Therefore, one PO can include multiple PMOs, or in other words, a PO is composed of a set of PMOs.

PMOs are a sequence of multiple monitoring occasions starting from a starting point, and PMOs are in one-to-one association with actually sent SSBs.

The terminal device can determine the position of an associated PF or PO based on its own device identity (UE_ID).

It may be noted that in embodiments of the disclosure, the PO can be understood both as a paging occasion and as a UE subgroup or UE group corresponding to the PO. The UE subgroup (or UE group) corresponding to the PO can be understood as a set of terminals that correspond/map/associate with the same PO. One PO can correspond to one UE group, which is not limited herein.

### 2. Radio Resource Management (RRM) Measurement

The terminal device in the RRC_IDLE or RRC_INACTIVE state also needs to perform periodic RRM measurements. RRM measurements can include serving cell measurements and neighboring cell measurements.

The neighboring cell measurement can include the following. The network device provides a certain frequency, and the terminal device can perform cell search and measurement on the frequency. Alternatively, the network device provides a certain frequency and physical cell ID (PCI), and the terminal device can use the PCI to perform cell search and measurement on the frequency. Alternatively, the network device does not provide any specific frequency or PCI, and the terminal device can autonomously perform cell search and measurement.

Neighboring cell measurements can also be divided into intra-frequency measurements and inter-frequency measurements.

For example, if the SSB of an object of the neighboring cell measurement has the same central frequency point and subcarrier spacing as the SSB of the serving cell, then this measurement is classified as an intra-frequency measurement.

For example, if the SSB of an object of the neighboring cell measurement has a different central frequency point or subcarrier spacing from the SSB of the serving cell, then this measurement is classified as an inter-frequency measurement.

The terminal device in the RRC_IDLE state or RRC_INACTIVE state generally needs to perform an RRM measurement of the serving cell within one paging cycle. The paging cycle is also known as a DRX cycle or an idle state DRX cycle.

Therefore, monitoring paging related PDCCH and performing RRM measurements are main tasks for the terminal device in the RRC_IDLE or RRC_INACTIVE state.

### 3. Paging Early Indication (PEI)

In order to monitor the paging related PDCCH and conduct RRM measurements, the network device generally needs to wake up terminal device from deep sleep to process three SSB burst, achieving a certain time-frequency synchronization to monitor the paging related PDCCH while conducting RRM measurements.

During the process of monitoring the paging related PDCCH, to avoid unnecessary monitoring and save power for the terminal device, the network device can configure PEI in the RRC_IDLE or RRC_INACTIVE state. The PEI can indicate whether the terminal device needs to continue monitoring the paging related PDCCH, in order to achieve power saving. The PEI can consist of downlink control information or sequences, etc.

When the PEI is configured, the terminal device can wake up from deep sleep to process one SSB burst to achieve a certain time-frequency synchronization to detect the PEI.

If the PEI indicates a monitoring occasion for continuing monitoring the paging related PDCCH, the terminal device continues to process the remaining two SSB bursts and continues to monitor the paging related PDCCH.

If the PEI indicates that monitoring the paging related PDCCH is not required to continue, the terminal device returns to deep sleep.

With a group paging rate of 10%, the terminal device needs to monitor the paging related PDCCH with a probability of 10%. Thus, at a 10% probability, the terminal device needs to process three SSB bursts, monitor the paging related PDCCH, and perform RRM measurements. At a 90% probability, the terminal device only needs to process one SSB burst and perform RRM measurements. Therefore, at a 90% probability, the terminal device processes fewer signals/channels, has a shorter wake-up time (if no signals/channels are processed after waking up from deep sleep, the terminal device remains in light sleep), and consumes less power.

In summary, by using PEI, terminal devices can achieve energy saving.

### III. LOW POWER WAKE-UP SIGNAL (LP-WUS) AND LOW POWER WAKE-UP SIGNAL RECEIVER (LP-WUR)

It may be noted that a low power wake-up signal receiver can also be referred to as a low power receiver, wake-up signal receiver (WUS receiver), etc. The low power wake-up signal receiver can be seen as a module primarily used to receive signals/channels related to low power wake-up signals.

### 1. Low Power Wake-Up Signal

The Network device can wake up the terminal device from a deep sleep state, such as power saving mode (PSM), by sending a low power wake-up signal. Accordingly, the terminal device determines whether it needs to exit the deep sleep state to enter RRC_IDLE state, RRC_INACTIVE state, or RRC_CONNECTED state by monitoring/detecting the low power wake-up signal. In this way, the terminal device can enter a deep sleep state while still being able to be woken up by the network.

To simplify the description, the low power wake-up signal in the disclosure can also be referred to as the wake-up signal (WUS). In other words, the “low power wake-up signal” in the disclosure can be collectively referred to as the “wake-up signal”.

### 2. Low Power Wake-Up Signal Receiver

In certain scenarios, the terminal device can simply turn on a low power wake-up signal receiver independent of the main radio. In this way, the terminal device can turn off the main radio to achieve energy saving (reduce power consumption) while still monitoring the low power wake-up signal through the low power wake-up signal receiver to wait to be awakened by the network, thus achieving network reachability. By using the main radio and the low power wake-up signal receiver, both energy saving and network reachability can be addressed simultaneously. In certain scenarios, the low power wake-up signal can be monitored at a relatively high frequency through the low power wake-up signal receiver, allowing the terminal device to be awakened with lower latency, therefore the low power wake-up signal receiver also has the potential benefit of reducing latency.

To simplify the description, the low-power wake-up signal receiver in the disclosure can also be referred to as a low-power receiver (LPR). In other words, the “low-power wake-up signal receiver” in the disclosure can be collectively referred to as a “low-power receiver”.

### 3. Reception Methods of Low-Power Receiver

In embodiments of the disclosure, the low-power receiver can have the following two types of reception methods.

### Type-1 Reception Method

In type-1 reception method, the low-power receiver periodically detects the wake-up signal.

In this method, the power consumption for a single wake-up signal detection is higher, but due to the long cycle (the low-power receiver only needs to wake up once in each long cycle for detection), the average power consumption is lower. Since it is necessary to wake up periodically for detection, the low-power receiver requires accurate time synchronization.

Additionally, in this method, due to frequency drift, the low-power receiver may have a timing error. When the cycle is excessively long, the accumulated error in timing will be excessive. When the error in timing exceeds a certain degree (such as exceeding one or more modulation symbols), the demodulation and decoding performance will sharply decline, resulting in a high miss detection rate (MDR) and/or false alarm rate (FAR).

### Type-2 Reception Method

In type-2 reception method, the low-power receiver remains in a state of detecting wake-up signals (also known as the stand-by state).

In this method, the power consumption for a single wake-up signal detection is low, and although the low-power receiver is continuously detecting, the average power consumption is also low. Since the low-power receiver is always detecting, the low-power receiver does not require very accurate time synchronization.

In this method, when the network device has not sent any wake-up signal for long time, the accumulated timing error may be excessive. When the timing error exceeds a certain level (such as exceeding one or more modulation symbol), the low-power receiver can assume multiple time points as the starting points for detection of the wake-up signal (if the wake-up signal is a channel, demodulation and decoding are performed; and if the wake-up signal is a signal, sequence-related operations are performed), which can reduce the impact of the timing error. However, if synchronization is not achieved for a long time, the time interval between the network device sending the wake-up signal and the low-power receiver detecting the wake-up signal becomes excessively large, resulting in excessive delay.

Therefore, the wake-up signal can also include synchronization signals for low-power receive synchronization (at least correcting the timing error, for envelope detection). Synchronization signals can be sent without using on-off keying (OOK) modulation. Synchronization signals can be sent in the form of frequency-domain sequences. Since a frequency-domain sequence manifests as a filtered time-domain sequence in the time-domain, the receiver can employ a time-domain correlation method (i.e., correlating the received time-domain signal with a local sequence or a time-domain version of a partial sequence). In fact, the time-domain correlation method is equivalent to the frequency-domain multiplication method (i.e., multiplying the received frequency-domain signal by a local sequence or a time-domain version of a partial sequence).

### 4. Architecture of Low Power Receiver

In embodiments of the disclosure, the low power receiver can have the following three architectures. The first architecture is a zero intermediate frequency (zero IF)-based envelope detection architecture, where the envelope detection can be completed in the baseband. The second architecture is a low intermediate frequency (low IF)-based envelope detection architecture, where the envelope detection can be completed in the IF. The third architecture is a radio frequency (RF)-based envelope detection architecture, where the envelope detection can be completed in the RF. All these three architectures can achieve the two types of reception methods of the low-power receiver.

### 5. Modulation of Wake-Up Signal

In embodiment of the disclosure, in order to reduce the complexity of the low-power receiver, the wake-up signal be subject to the OOK modulation.

This is because the OOK modulation only has amplitude information, and no frequency or phase information, with only two amplitudes: high and low (or zero). For OOK, the reception method can be envelope detection, which can directly accumulate the amplitude of the received signal. Due to its simplicity, the power consumption required is relatively low. In this way, the low-power receiver in the terminal device can be simplified to detecting the energy of the modulation symbols (rather than the amplitude/phase of the modulation symbols). As long as the energy of the detected modulation symbol exceeds a certain threshold, it can be determined as on; otherwise, it is determined as off.

Additionally, since processing is done in the RF or IF, envelope detection can be employed.

### 6. Waveform of Wake-Up Signal

The waveform of the wake-up signal can be a single tone waveform or a single carrier waveform, or it can be a multi-tone waveform or a multi-carrier waveform.

For OOK of a single-tone or single-carrier waveform, one OOK modulation symbol can be a time-domain symbol of a single tone or single carrier.

For OOK of a multi-tone or multi-carrier waveform, one OOK modulation symbol can be a time-domain symbol of multiple tones or multiple carriers, such as an orthogonal frequency division multiplexing (OFDM) time-domain symbol.

For OOK of a multi-tone or multi-carrier waveform, at the transmitter (e.g., the network device), the values of multiple subcarriers of a modulation symbol can be random or preset.

In order to map multiple OOK modulation symbols to one OFDM symbol, waveform shaping is often required, such as pre-coding (e.g., discrete Fourier transform (DFT) pre-coding, pseudo-inverse-based pre-coding) the OOK modulation symbol sequence, and then mapping the pre-coded OOK modulation symbol sequence to corresponding subcarriers. Another benefit is that an OFDM symbol can contain OOK modulation symbols for low-power wake-up signals as well as modulation symbols for other signal channels.

For OOK of a multi-tone or multi-carrier waveform, one way at the receiver (such as the low-power receiver in the terminal device) is envelope detection, which has lower complexity and lower power consumption at the receiver, but poor detection performance. Another way is sequence detection, where the received sequence is correlated with a local sequence to detect an OOK sequence, which has better detection performance but higher complexity and power consumption at the receiver, and in this case the sequence generally carries fewer bits.

### IV. OPTIMIZATION PROCESSING OF WAKE-UP SIGNAL SEQUENCE

Inter-cell interference randomization is very beneficial for the communication process in the communication system. To achieve inter-cell interference randomization, it is usually necessary to ensure that the sequence (channel/signal) to be transmitted has a longer sequence length to reduce the correlation/association among various sequences (channels/signals).

However, due to the short length of the wake-up signal sequence, it may not be possible to ensure inter-cell interference randomization in cases with many cell identities (IDs) through the wake-up signal. Therefore, the wake-up signal sequence is considered to be optimized to increase the length of the wake-up signal sequence, or to increase the length of data of the wake-up signal, so as to minimize the correlation/association among wake-up signals and ensure inter-cell interference randomization.

### 1. Wake-Up Signal Sequence

It may be noted that, for understanding of the wake-up signal sequence, the wake-up signal sequence can be represented in the form of a sequence at a higher layer (such as RRC layer or MAC layer) or the physical layer, and the sequence can represent a bit sequence or a combination of multiple bits, allowing for corresponding processing of the sequence (such as channel coding, bit-level processing, etc.).

For a bit sequence, the bit sequence can consist of multiple bits, and thus these bits can be processed accordingly in embodiments of the disclosure.

Additionally, since various bits in the bit sequence may be arranged in ascending order from low to high, the entire bits of this bit sequence can include multiple most significant bits and multiple least significant bits.

For example, a bit sequence has 8 bits, which are ‘hgfedcba’, where ‘a’ is the 0ₜₕ bit, ‘b’ is the 1^{st} bit, ‘c’ is the 2^{nd} bit, . . . , and ‘h’ is the 7^{th} bit.

For multiple least significant bits, the 0^{th} bit (i.e. ‘a’) can be seen as 1 least significant bit; the 0^{th} bit and the 1^{st} bit (i.e. ‘ba’) can be seen as 2 least significant bits; the 0^{th} bit, the 1^{st} bit, and the 2^{nd} bit (i.e. ‘cba’) can be seen as 3 least significant bits, and so on.

For multiple most significant bits, the 7^{th} bit (i.e. ‘h’) can be seen as 1 most significant bit; the 7^{th} bit and the 6^{th} bit (i.e. ‘hg’) can be seen as 2 most significant bits; the 7^{th} bit, the 6^{th} bit, and the 5^{th} bit (i.e. ‘hgf’) can be seen as 3 most significant bits, and so on.

### 2. Specific Implementations

The following embodiments of the disclosure will illustrate how to optimize the wake-up signal sequence from various implementations. Any combination of the various implementations can be made to form new implementations, which are also within the scope of protection sought in the disclosure, and will not be elaborated further.

### Implementation 1:

### \textcircled{1} Description

In “Implementation 1”, an increase in sequence length is required in this embodiments of the disclosure, that is, an increase in the number of bits in the sequence.

For convenience in description and differentiation, a first sequence and a second sequence are introduced in embodiments of the disclosure. The first sequence is processed to output the second sequence. Here, the sequence length of the second sequence (i.e., the number of bits) is greater than the sequence length of the first sequence (i.e., the number of bits).

Specifically, the processing may include repeating, up-sampling, or bit padding, etc.

It may be noted that repeating or up-sampling can be understood as using original bits of the first sequence to perform repetition-based bit padding or bit up-sampling, so as to increase the number of bits in the first sequence, thus outputting/obtaining the second sequence.

For example, if the first sequence includes 32 bits, the transmitter of the network device can repeat or up-sample these 32 bits, meaning that these 32 bits are repeated 36 times, resulting in a total of 1152 bits.

The bit padding can be performed by padding using original bits of the first sequence for multiple repetitions or by padding using preset bits (such as empty bits) for multiple repetitions, etc., in order to increase the number of bits in the first sequence, thus outputting/obtaining the second sequence.

By processing in this way to increase the sequence length of the first sequence, i.e., to increase the number of bits in the first sequence, the correlation/association among various first sequences can be minimized, thus ensuring the inter-cell interference randomization.

### \textcircled{2} First Sequence

In some possible implementations, the first sequence can represent a wake-up signal sequence, which could be a coded bit sequence or a bit sequence of the wake-up signal after encoding, such as a coded codeword. Correspondingly, the second sequence can be a bit sequence after processing the first sequence (such as repeating or up-sampling).

For example, the transmitter of the network device can encode a partial UE ID that has 16 bits in the wake-up signal to obtain a bit sequence with 32 bits (i.e., the first sequence).

Similarly, the first sequence q is a bit sequence

$${a}^{( q )} ( 0 ) , ... , {a}^{( q )} ( {M}_{bit}^{( q )} - 1 ) , and {M}_{bit}^{( q )}$$

is the total number of bits in the first sequence q. After processing the first sequence q (such as repeating or up-sampling), the output second sequence is a bit sequence

$${b}^{( q )} ( 0 ) , ... , {b}^{( q )} ( {L}_{bit}^{( q )} - 1 ) , {b}^{( q )} ( 0 ) , ... , {b}^{( q )} ( {L}_{bit}^{( q )} - 1 ) ,$$

Specifically, the coding can be channel coding; or channel coding plus cyclic redundant check (CRC) coding; or code block segmentation plus CRC coding; or rate matching and code block concatenation plus code block CRC coding. Channel coding can be a type of forward error correcting coding.

### \textcircled{3} Carrying First Sequence in One or More OFDM Symbols

In some possible implementations, the first sequence may be carried within one or more OFDM symbols.

It may be noted that due to the relatively short length of the wake-up signal sequence, the first sequence obtained from encoding the wake-up signal sequence may still have a relatively short length. This may lead to the number of bits to be carried being far smaller than the number of bits that can be carried by the subcarriers allocated within one or more OFDM symbols. Therefore, in the disclosure, through processing (such as repeating or up-sampling), the number of bits to be carried matches the number of bits that can be carried by the subcarriers allocated within one or more OFDM symbols.

Thus, in embodiments of the disclosure, the length of the first sequence (i.e., the number of bits in the first sequence) can be increased through the aforementioned processing (such as repeating or up-sampling), so that the number of bits in the first sequence may be as close to the number of bits carried in subcarriers finally mapped as possible.

### \textcircled{4} Subsequent Processing on Second Sequence

a. Description

It may be noted that in embodiments of the disclosure, the second sequence can be modulated to output a third sequence, and then the third sequence is pre-coded to output a fourth sequence. The following provides a specific explanation.

b. Modulation

Modulation may be a type of generation process of shifting keying or constellation. Specifically, modulation can be OOK modulation, phase shift keying (PSK) modulation, frequency shift keying (FSK) modulation, amplitude shift keying (ASK) modulation, or quadrature amplitude modulation (QAM). The third sequence can be regarded as a “time-domain” symbols or modulation symbols.

For example, the second sequence is a bit sequence

$${b}^{( q )} ( 0 ) , ... , {b}^{( q )} ( {L}_{bit}^{( q )} - 1 ) , {b}^{( q )} ( 0 ) , ... , {b}^{( q )} ( {L}_{bit}^{( q )} - 1 ) ,$$

The second sequence is modulated to output the third sequence as modulation symbols

$${d}^{( q )} ( 0 ) , ... , {d}^{( q )} ( {M}_{symb}^{( q )} - 1 ) , {d}^{( q )} ( 0 ) , ... , {d}^{( q )} ( {M}_{symb}^{( q )} - 1 ) ,$$

That is to say, the transmitter of the network device can modulate the output second sequence that has been subject to processing (such as repeating or up-sampling), thereby converting the second sequence into modulation symbols. Modulation symbols can also be referred to as “time-domain” symbols, since OOK modulation is generally time-domain modulation, and a waveform corresponding to the OOK modulation is usually a single carrier waveform.

For example, if the second sequence has 1152 bits and these 1152 bits need to be carried by 8 OFDM symbols, then each OFDM symbol carries 114 bits. Then, the 114 bits on each OFDM symbol are modulated to obtain 144 modulation symbols.

It may be noted that, in conjunction with the above content of “5. Modulation of Wake-up Signal”, the network device can modulate using OOK, while the low-power receiver in the terminal device can demodulate using OOK. Due to the simplicity of OOK, the low-power receiver in the terminal device can be simplified to detecting the energy of the modulation symbols, only needing to detect if the energy of the modulation symbols exceeds a certain threshold, thereby simplifying the low-power receiver.

c. Pre-Coding

Specifically, pre-coding can be used to perform “domain conversion” (for example, converting “time-domain” into “frequency-domain”) on the third sequence to obtain the fourth sequence, which is then mapped to subcarriers. The fourth sequence can be regarded as “frequency-domain” symbols, as the fourth sequence is mapped to frequency-domain subcarriers.

That is to say, the network devices can convert modulation symbols into “frequency-domain” symbols through pre-coding and map the “frequency-domain” symbols to subcarriers for frequency division multiplexing with other OFDM-based signals/channels.

For example, if the second sequence has 1152 bits and these 1152 bits need to be carried by 8 OFDM symbols, then each OFDM symbol carries 114 bits. The 114 bits on each OFDM symbol are modulated to obtain 144 modulation symbols. Finally, the 144 modulation symbols are pre-coded to obtain 144 “frequency-domain” symbols, which can be mapped to 144 subcarriers.

It may be noted that, in conjunction with the content of “6. Waveform of Wake-up Signal”, waveform shaping is achieved through pre-coding, allowing one OFDM symbol to contain both OOK modulation symbols for low-power wake-up signals and modulation symbols for other signal channels.

Specifically, pre-coding may include discrete Fourier transform (DFT) pre-coding or pseudo-inverse-based pre-coding.

It can be seen that through DFT pre-coding or pseudo-inverse-based pre-coding, the low-power receiver in the terminal device can detect OOK symbols by performing inverse discrete Fourier transform (IDFT) decoding or without decoding, thereby reducing the power consumption of the low-power receiver.

### Implementation 2:

### \textcircled{1} Description

Based on the content of “Implementation 1”, in “Implementation 2”, in this embodiment of the disclosure, the first sequence is subject to processing (such as repeating or up-sampling) similarly to output a second sequence. “Implementation 2” is different from “Implementation 1” in that the subsequent processing on the second sequence additionally considers the scrambling of the second sequence, which will be explained in detail below.

### \textcircled{2} Subsequent Processing on Second Sequence

a. Description

It may be noted that in this embodiment of the disclosure, the second sequence may be scrambled to output a fifth sequence, and the fifth sequence is modulated to output a sixth sequence, and the sixth sequence is finally pre-coded to output a seventh sequence.

b. Scrambling

Specifically, scrambling can be performed by multiplying the second sequence with a scrambling sequence to output the fifth sequence. In this way, scrambling can ensure the inter-cell interference randomization as much as possible, thereby reducing inter-cell interference.

For example, the second sequence is a bit sequence

$${b}^{( q )} ( 0 ) , ... , {b}^{( q )} ( {L}_{bit}^{( q )} - 1 ) , {b}^{( q )} ( 0 ) , ... , {b}^{( q )} ( {L}_{bit}^{( q )} - 1 ) ,$$

The second sequence is scrambled to output a fifth sequence as a bit sequence

$${\tilde{b}}^{( q )} ( 0 ) , ... , {\tilde{b}}^{( q )} ( {L}_{bit}^{( q )} - 1 ) , {\tilde{b}}^{( q )} ( 0 ) , ... , {\tilde{b}}^{( q )} ( {L}_{bit}^{( q )} - 1 ) , ... . ,$$

where the i^{th}

$$( i ∈ \{ 0 , ... , {M}_{bit}^{( q )} - 1 , ... \} )$$

bit is defined as follows: \tilde{b}^{(q)}(i)=(b^{(q)}(i)+c^{(q)}(i)) mod 2. c^{(q)}(i) denotes the scrambling sequence, which is a pseudo-random sequence c (n) with a length of M_{PN}, where n=0, 1, . . . , M_{PN}−1. The following is further defined:

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2

N_{C}=1600, and the first m-sequence x₁(n) is initialized as x₁(0)=1, x₁(n)=0, n=1, 2, . . . , 30, and the initialization of the second m-sequence x₂(n) is according to the following formula:

$${c}_{init} = {\sum }_{i = 0}^{30} {x}_{2} ( i ) \cdot {2}^{i} .$$

cᵢₙᵢₜ denotes the scrambling initialization sequence, and cᵢₙᵢₜ can be used for initialization of x₂(n). cᵢₙᵢₜ can carry up to 31 bits of information. cᵢₙᵢₜ can serve as the initial value of the scrambling sequence generator, and the scrambling sequence generator can be used to generate scrambling sequences and is defined as follows:

$${c}_{init} = f ( {N}_{ID}^{cell} ) ; or , {c}_{init} = f ( {N}_{ID}^{cell} , {n}_{ID} ) ; \\ or , {c}_{init} = f ( {N}_{ID}^{cell} , {n}_{ID} , {n}_{RNTI} ) .$$

f( ) denotes a generating function.

$${N}_{ID}^{cell}$$

denotes part or all bits of a cell identity (ID). There exist 1008 unique cell identities, and the following is defined:

$${N}_{ID}^{cell} = 3 {N}_{ID}^{( 1 )} + {N}_{ID}^{( 2 )} \cdot {N}_{ID}^{( 1 )} ∈ \{ 0 , 1 , ... , 335 \}$$

can be determined based on the primary synchronization signal (PSS);

$${N}_{ID}^{( 2 )} ∈ \{ 0 , 1 , 2 \}$$

and can be determined based on the secondary synchronization signal (SSS). n_{ID}∈{0, 1, . . . , 1023} and denotes the data scrambling identity. N_{RNTI} corresponds to a transmission-related radio network temporary identity (RNTI).

In summary, in some possible implementations, the scrambling sequence or the initial value cᵢₙᵢₜ of the scrambling sequence generator used for scrambling may contains the cell identity

$$( {N}_{ID}^{cell} ) .$$

In this way, the fifth sequence output after scrambling can carry the cell identity, allowing the wake-up signal to carry the cell identity.

Optionally, the cell identity can be part or all of the bits of the cell identity. In other words, the wake-up signal can carry part or all of the bits of the cell identity. When the wake-up signal carries part of the bits of the cell identity, the remaining bits of the cell identity need to be carried by other signals.

Optionally, in conjunction with the content in “1. Wake-up Signal Sequence”, the part of the bits of the cell identity can include multiple most significant bits and multiple least significant bits of the cell identity.

c. Modulation

Modulation may be a generation process of shifting keying or constellation. Specifically, modulation can be OOK modulation, PSK modulation, FSK modulation, ASK modulation, or QAM. The sixth sequence can be regarded as modulation symbols. Modulation symbols can also be referred to as “time-domain” symbols, as OOK modulation is generally time-domain modulation, and a waveform corresponding to the OOK modulation is generally a single carrier waveform.

That is to say, the network device can scramble the second sequence subject to processing (such as repeating or up-sampling), and then modulate the output fifth sequence after scrambling to output the sixth sequence.

For example, if the second sequence has 1152 bits, the 1152 bits are scrambled to obtain scrambled 1152 bits. If the 1152 scrambled bits require to be carried by 8 OFDM symbols, then each OFDM symbol carries 114 scrambled bits. Then, the 114 scrambled bits on each OFDM symbol are modulated to obtain 144 “time-domain” symbols or modulation symbols.

It may be noted that, in conjunction with the above content of “5. Modulation of Wake-up Signal”, the network device can modulate using OOK, while the low-power receiver in the terminal device can demodulate using OOK. Due to the simplicity of OOK, the low-power receiver in the terminal device can be simplified to detecting the energy of the modulation symbols, only needing to detect if the energy of the modulation symbols exceeds a certain threshold, thereby simplifying the low-power receiver.

d. Pre-Coding

Specifically, pre-coding can be used to perform “domain conversion” on the sixth sequence (such as converting “time-domain” to “frequency-domain”) to obtain the seventh sequence, which is then mapped to subcarriers. The seventh sequence can be regarded as “frequency-domain” symbols, because the seventh sequence is mapped to frequency-domain subcarriers.

That is to say, the network device can convert modulation symbols into “frequency-domain” symbols through pre-coding and map the “frequency-domain” symbols to subcarriers for frequency division multiplexing with other OFDM-based signals/channels.

For example, if the second sequence has 1152 bits, the 1152 bits are scrambled to obtain 1152 scrambled bits. If the 1152 scrambled bits need to be carried by 8 OFDM symbols, then each OFDM symbol carries 114 scrambled bits. The 114 scrambled bits on each OFDM symbol are modulated to obtain 144 modulation symbols. Finally, the 144 modulation symbols are pre-coded to obtain 144 “frequency-domain” symbols, which can be mapped to 144 subcarriers.

It may be noted that, in conjunction with the content in “6. Waveform of Wake-up Signal” above, waveform shaping is achieved through pre-coding, allowing an OFDM symbol to contain both OOK modulation symbols for low-power wake-up signals and modulation symbols for other signal channels.

Specifically, the pre-coding can include DFT pre-coding or pseudo-inverse-based pre-coding.

It can be seen that through DFT pre-coding or pseudo-inverse-based pre-coding, the low-power receiver in the terminal device can detect OOK symbols by performing IDFT decoding or without decoding, thereby reducing the power consumption of the low-power receiver.

### Implementation 3:

### \textcircled{1} Description

In “Implementation 3”, an increase in the sequence length is still required in this embodiment of the disclosure, that is, an increase in the number of bits in the sequence.

The difference from “Implementation 1” and “Implementation 2” is that in “Implementation 3”, in this embodiment of the disclosure, the first sequence is modulated to output an eighth sequence, and then the eighth sequence is pre-coded to output a ninth sequence. The length (i.e., the number of bits) of the ninth sequence is greater than the length (i.e., the number of bits) of the first sequence.

It may be noted that in embodiments of the disclosure, original bits of the first sequence may be padded through modulation and/or pre-coding (the padding can be implemented by padding using the original bits for multiple repetitions or by padding using preset bits (such as empty bits) for multiple repetitions, etc.) to increase the number of bits in the first sequence, thereby outputting/obtaining the ninth sequence.

In this way, the length of the first sequence is increased through modulation and pre-coding, that is, the number of bits in the first sequence is increased in order to reduce the correlation/association among various first sequences as much as possible, ensuring inter-cell interference randomization.

a. Modulation

Modulation is a generation process of shifting keying or constellation. Specifically, modulation can be OOK modulation, PSK modulation, FSK modulation, ASK modulation, or QAM. The eighth sequence can be regarded as modulation symbols. Modulation symbols can also be called “time-domain” symbols, as OOK modulation is generally time-domain modulation, and a waveform corresponding to the OOK modulation is generally a single carrier waveform.

For example, the first sequence q is a bit sequence

$${a}^{( q )} ( 0 ) , ... , {a}^{( q )} ( {M}_{bit}^{( q )} - 1 ) , and {M}_{bit}^{( q )}$$

is the total number of bits in the first sequence q. The first sequence q is modulated to output the eighth sequence as modulation symbols

$${d}^{( q )} ( 0 ) , ... , {d}^{( q )} ( {M}_{symb}^{( q )} - 1 ) .$$

That is to say, the network device can modulate the first bit sequence to output the eighth sequence.

It may be noted that, in conjunction with the above content of “5. Modulation of Wake-up Signal”, the network device can modulate using OOK, while the low-power receiver in the terminal device can demodulate using OOK. Due to the simplicity of OOK, the low-power receiver in the terminal device can be simplified to detecting the energy of the modulation symbols, only needing to detect if the energy of the modulation symbols exceeds a certain threshold, thereby simplifying the low-power receiver.

In some possible implementations, the eighth sequence can be carried in one or more OFDM symbols.

It may be noted that due to the relatively short length of the first sequence, the length of the eighth sequence obtained from modulating the first sequence may still be relatively short. This may result in the number of bits to be carried being much smaller than the number of bits that can be carried by the subcarriers allocated within one or more OFDM symbols. Therefore, in the disclosure, the number of bits to be carried matches the number of bits that can be carried by the subcarriers allocated within one or more OFDM symbols through processing (such as repeating or up-sampling).

Thus, in this embodiment of the disclosure, the length of the eighth sequence is increased (i.e., the number of symbols in the eighth sequence is increased) through the aforementioned pre-coding, so that so that the number of bits in the eight sequence may be as close to the number of bits carried in subcarriers finally mapped as possible.

Specifically, the number of symbols in the input eighth sequence to be pre-coded is N, and the number of symbols in the output ninth sequence is N*X, where X is an integer greater than or equal to 1. In other words, the number of symbols in the eighth sequence is increased through the aforementioned pre-coding.

For example, if the first sequence has 32 bits and these 32 bits require to be carried in 8 OFDM symbols, and each OFDM symbol carries 4 bits. Then, the network device can modulate these 4 bits to obtain 4 modulation symbols. Finally, the 4 modulation symbols are pre-coded to obtain 144 “frequency-domain” symbols, which are mapped to 144 subcarriers. It can be seen that the number of input symbols to be pre-coded is 4, and the number of out symbols is 144. In this case, N=4, X=36, which is equivalent to processing of 36 times (such as repeating or up-sampling).

b. Pre-Coding

Specifically, pre-coding can be used to perform a “domain transformation” on the eighth sequence (such as converting from “time-domain” to “frequency-domain”) to obtain the ninth sequence and map the ninth sequence onto subcarriers. The ninth sequence can be regarded as “frequency-domain” symbols because the ninth sequence is mapped to frequency-domain subcarriers.

That is to say, the network device can convert modulation symbols into “frequency-domain” symbols through pre-coding and map the “frequency-domain” symbols to subcarriers for frequency division multiplexing with other OFDM-based signals/channels.

For example, the eighth sequence is

$${d}^{( q )} ( 0 ) , ... , {d}^{( q )} ( {M}_{symb}^{( q )} - 1 ) ,$$

and the eighth sequence is pre-coded to output the ninth sequence as:

$$[ \begin{matrix}{z}^{( q )} ( 0 ) \\ ⋮ \\ {z}^{( q )} ( {L}_{symb}^{( q )} - 1 )\end{matrix} ] = W [ \begin{matrix}{d}^{( q )} ( 0 ) \\ ⋮ \\ {d}^{( q )} ( {M}_{symb}^{( q )} - 1 )\end{matrix} ] .$$

$${L}_{symb}^{( q )}$$

denotes the total number of symbols in the ninth sequence, and

$${L}_{symb}^{( q )} > {M}_{symb}^{( q )} .$$

W denotes a pre-coding matrix.

It may be noted that, in conjunction with the content in “6. Waveform of Wake-up Signal”, waveform shaping is achieved through pre-coding, allowing an OFDM symbol to contain both OOK modulation symbols for low-power wake-up signals and modulation symbols for other signal channels.

Specifically, the pre-coding can include DFT pre-coding or pseudo-inverse-based pre-coding.

It can be seen that through DFT pre-coding or pseudo-inverse-based pre-coding, the low-power receiver in the terminal device can detect OOK symbols by performing IDFT decoding or without decoding, thereby reducing the power consumption of low-power receiver.

### Implementation 4:

### \textcircled{1} Description

Based on the content in “Implementation 3” above, in “Implementation 4”, in embodiments of the disclosure, the first sequence is also modulated to output the eighth sequence by, and then the eighth sequence is pre-coded to output the ninth sequence. Here, the difference from “Implementation 3” is that the embodiment of the disclosure also requires subsequent processing on the ninth sequence, which will be explained in detail below.

### \textcircled{2} Subsequent Processing on Ninth Sequence

a. Description
a.

It may be noted that in the embodiment of the disclosure the ninth sequence may be scrambled to output the tenth sequence.

b. Scrambling

Specifically, scrambling can be performed by multiplying the ninth sequence with a scrambling sequence to output the tenth sequence. In this way, scrambling can ensure the inter-cell interference randomization as much as possible, thereby reducing inter-cell interference. The scrambling sequence can be a bipolar scrambling sequence, which is converted from a unipolar scrambling sequence (such as values of 0 or 1) to a bipolar sequence (such as values of 1 or −1). For example, the ninth sequence is

$${z}^{( q )} ( 0 ) , ... , {z}^{( q )} ( {L}_{symb}^{( q )} - 1 ) .$$

After scrambling the ninth sequence, the output tenth sequence is

$${\tilde{z}}^{( q )} ( 0 ) , ... , {\tilde{z}}^{( q )} ( {L}_{symb}^{( q )} - 1 ) .$$

### The j^{th}

$$( j ∈ \{ 0 , ... , {L}_{symb}^{( q )} - 1 \} )$$

symbol \tilde{z}^{(q)}(j) is defined as follows: \tilde{z}^{(q)}(i)=g (z^{(q)}(i),c^{(q)}(j)).

g( ) denotes the scrambling function. c^{(q)}(j) denotes the scrambling sequence, which is a pseudorandom sequence c(n). The length of c(n). is M_{PN}, n=0, 1, . . . , M_{PN}−1, and the followings are defined:

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2.

N_{C}=1600. The first m-sequence is initialized as x₁(0)=1, x₁(n)=0,n=1, 2, . . . , 30. The initialization of the second m-sequence is determined by the following formula:

$${c}_{init} = {\sum }_{i = 0}^{30} {x}_{2} ( i ) \cdot {2}^{i} .$$

cᵢₙᵢₜ denotes the scrambling initialization sequence, and cᵢₙᵢₜ can be used for initialization and can carry up to 31 bits of information. cᵢₙᵢₜ can serve as the initial value of the scrambling sequence generator, and the scrambling sequence generator can be used to generate scrambling sequences (unipolar scrambling sequences) and is defined as follows:

$${c}_{init} = h ( {N}_{ID}^{cell} ) ; or , {c}_{init} = h ( {N}_{ID}^{cell} , {n}_{ID} ) ; \\ or , {c}_{init} = h ( {N}_{ID}^{cell} , {n}_{ID} , {n}_{RNTI} ) .$$

h( ) denotes a generating function.

In summary, in some possible implementations, the scrambling sequence or the initial value of the scrambling sequence generator used for scrambling contains the cell identity

$$( {N}_{ID}^{cell} ) .$$

Thus, the output scrambled tenth sequence can carry the cell identity, allowing the wake-up signal to carry the cell identity.

Optionally, the cell identity can be part of the bits or all of the bits of the cell identity. In other words, the wake-up signal can carry part of the bits or all of the bits of the cell identity. When the wake-up signal carries part of the bits of the cell identity, the remaining bits of the cell identity need to be carried by other signals.

Optionally, in conjunction with the content in “1. Wake-up Signal Sequence”, the part of the bits of the cell identity can include multiple most significant bits and multiple least significant bits of the cell identity.

### Implementation 5:

### \textcircled{1}Description

In the “Implementation 1” or “Implementation 2”, the transmitter of the network device increases the sequence length through processing (such as repeating or up-sampling). However, since the sampling rate of the low-power receiver of the terminal device is lower than that of the transmitter of the network device, the network device only performs processing once, which may not guarantee the descrambling of the low-power receiver of the terminal device.

For example, if the second sequence output by the transmitter of the network device after one processing has 1152 bits, and these 1152 bits require to be carried in 8 OFDM symbols, then each OFDM symbol carries 114 bits. Then, the 114 bits on each OFDM symbol are modulated to obtain 144 modulation symbols. Finally, the 144 modulation symbols are pre-coded to obtain 144 “frequency-domain” symbols, which can be mapped to 144 subcarriers.

In this case, for a 15 kHz subcarrier, the sampling rate of the transmitter of the network device is at least 15 kHz*144=2.16M (sample/second). However, due to the sampling rate of the analog digital converter (ADC) in the low-power receiver of the terminal device being generally lower than the sampling rate of the ADC of the main radio and also lower than the sampling rate of the transmitter of the network device, the sampling rate of the low-power receiver in the terminal device for a 15 kHz subcarrier is at least 15 kHz*16=240 k (sample/second). Since the sampling rate of 240 k (sample/second) of the low-power receiver in the terminal device is 240 k (sample/second), which is lower than the sampling rate of 2.16M (sample/second) of the transmitter of the network device, if the network device only processes once, the descrambling of the low-power receiver in the terminal device may not be guaranteed.

Based on this, in “Implementation 5”, in the embodiment of the disclosure, the first is processed for a first time to output the eleventh sequence, and then the processing for the second time is performed to ensure the descrambling of the low-power receiver in the terminal device. The sequence length (i.e., the number of bits) of the eleventh sequence is greater than the sequence length (i.e., the number of bits) of the first sequence.

Specifically, the processing for the first time can include repeating for the first time, up-sampling for the first time, or bit padding for the first time, etc.

It may be noted that repeating for the first time or up-sampling for the first time can be understood as using the original bits of the first sequence to perform repetition-based bit padding or bit up-sampling for the first time, in order to increase the number of bits in the first sequence, thereby outputting/obtaining the eleventh sequence.

For example, if the first sequence has 32 bits, the transmitter of the network device can perform repeating or up-sampling for the first time on the 32 bits, such as perform repeating or up-sampling on the 32 bits 4 times, ultimately obtaining 128 bits in the eleventh sequence.

Bit padding for the first time can involve using the original bits of the first sequence to conduct multiple repetitions of padding for the first time, or using preset bits (such as empty bits) to perform multiple repetitions of padding, etc., in order to increase the number of bits in the first sequence, thereby outputting/obtaining the second sequence.

In this way, by increasing the length of the first sequence through the first processing, that is, increasing the number of bits in the first sequence, it helps to minimize the correlation/relation among various first sequences and ensure the inter-cell interference randomization.

### \textcircled{2} Subsequent Processing on Eleventh Sequence

a. Description

It may be noted that in the embodiment of the disclosure the eleventh sequence can be scrambled to output the twelfth sequence, then the twelfth sequence is subject to repeating or un-sampling for the second time to output a thirteenth sequence. The thirteenth sequence is modulated to output a fourteenth sequence, and the fourteenth sequence is pre-coded to output a fifteenth sequence.

In addition, it may be noted that the processing for the first time may also be omitted. In this case, the first sequence can be scrambled to output the twelfth sequence, followed by repeating or up-sampling for the second time on the twelfth sequence to output the thirteenth sequence, and finally modulate the thirteenth sequence to output the fourteenth sequence, as well as perform pre-coding on the fourteenth sequence to output the fifteenth sequence.

b. Scrambling

Specifically, scrambling can be performed by multiplying the eleventh sequence with a scrambling sequence to output the twelfth sequence. In this way, scrambling can ensure the inter-cell interference randomization as much as possible, thereby reducing inter-cell interference.

For example, if the eleventh sequence has 128 bits, then the 128 bits are scrambled to obtain scrambled 128 bits in the twelfth sequence.

In some possible implementations, the scrambling sequence or the initial value cᵢₙᵢₜ of the scrambling sequence generator contains the cell identity

$$( {N}_{ID}^{cell} ) .$$

Thus, the twelfth sequence output after scrambling can carry the cell identity, allowing the wake-up signal to also carry the cell identity.

Optionally, the cell identity can be part of the bits or all of the bits of that cell identity. In other words, the wake-up signal can carry part of the bits or all of the bits of the cell identity. When the wake-up signal carries part of the bits of the cell identity, the remaining bits of the cell identity need to be carried by other signals.

Optionally, in conjunction with the content in “1. Wake-up Signal Sequence”, the part of the bits of the cell identity can include multiple most significant bits and multiple least significant bits of the cell identity.

c. Processing for Second Time

Specifically, the processing for the second time can include repeating for the time, up-sampling for the time, or bit padding for the time, etc. It may be noted that the repeating for the time or up-sampling for the time can be understood as using the original bits of the twelfth sequence to perform repetition-based bit padding or bit up-sampling for the second time, so as to increase the number of bits in the twelfth sequence, thereby outputting/obtaining the thirteenth sequence.

For example, if the twelfth sequence has 128 bits, the transmitter of the network device can perform repeating or up-sampling on the 32 bits for the second time, such as repeating or up-sampling these 32 bits 9 times, resulting in to obtain 1152 bits in the thirteenth sequence.

The bit padding for the second time can be implemented by performing multiple repetitions of padding for the second time by using the original bits of the twelfth sequence, or performing multiple repetitions of padding by using preset bits (such as empty bits) for the second time, to increase the number of bits in the twelfth sequence, thus outputting/obtaining the thirteenth sequence.

In this way, through the processing for the second time, the length of the twelfth sequence is increased (which can be understood as further increasing the length of the first sequence), that is the number of bits in the twelfth sequence is increased, thereby guaranteeing the descrambling of the low-power receiver of the terminal device, while minimizing the correlation/association among various first sequences and ensuring the inter-cell interference randomization.

d. Modulation

Modulation is a generation process of shifting keying or constellation. Specifically, modulation can be OOK modulation, PSK modulation, FSK modulation, ASK modulation, or QAM. The fourteenth sequence can be seen as modulation symbols. Modulation symbols can also be called “time-domain” symbols, as OOK modulation is generally time-domain modulation, and a waveform corresponding to the OOK modulation is generally a single carrier waveform.

That is to say, the network device can modulate the thirteenth sequence output after undergoing repeating or up-sampling for the second time to output the fourteenth sequence.

It may be noted that, in conjunction with the content in “5. Modulation of wake-up signal”, the network device can modulate using OOK, while the low-power receiver in the terminal device can demodulate using OOK. Due to the simplicity of OOK, the low-power receiver in the terminal device can be simplified to detecting the energy of the modulation symbols, only needing to detect if the energy of the modulation symbols exceeds a certain threshold, thereby simplifying the low-power receiver.

e. Pre-Coding

Specifically, pre-coding can be used to perform “domain transformation” on the fourteenth sequence (such as converting “time-domain” to “frequency-domain”) to obtain the fifteenth sequence and map the fifteenth sequence to subcarriers. The fifteenth sequence can be regarded as “frequency-domain” symbols, as the fifteenth sequence is mapped to the frequency-domain subcarriers.

That is to say, the network device can convert modulation symbols into “frequency-domain” symbols through pre-coding and map the “frequency-domain” symbols to subcarriers for frequency division multiplexing with other OFDM-based signals/channels.

It may be noted that, in conjunction with the content in “6. Waveform of Wake-up Signal”, waveform shaping is implemented through pre-coding, allowing an OFDM symbol to contain both OOK modulation symbols for low-power wake-up signals and modulation symbols for other signal channels.

Specifically, the pre-coding can include DFT pre-coding or pseudo-inverse-based pre-coding.

It can be seen that through DFT pre-coding or pseudo-inverse-based pre-coding, the low-power receiver in the terminal device can detect OOK symbols by performing IDFT decoding or without decoding, thereby reducing the power consumption of the low-power receiver.

### 4. Exemplary Illustration of Wake-Up Signal Processing Method

### 1). Description

In conjunction with the contents of “Implementation 1” and “Implementation 2”, the following provides an exemplary introduction of a wake-up signal processing method in embodiments of the disclosure. It may be noted that this method can be applied to a network device. The network device can be a chip, chip module, or communication module, etc., which is not specifically limited herein.

As illustrated in FIG. 2, which is a flowchart of a wake-up signal processing method in embodiments of the disclosure, the method specifically includes the following.

S210, a first sequence is processed and a second sequence is output.

It may be noted that terms such as “processing for a first time”, “processing”, and “processing for a second time” are detailed in the above content and will not be elaborated further herein.

It can be seen that in the disclosure, the length of the first sequence is increased through processing, that is, the number of bits in the first sequence is increased, thus achieving the processing on the wake-up signal, so as to minimize the correlation/association among various first sequences and ensure inter-cell interference randomization.

### 2) Some Possible Implementations

In conjunction with the above content, the following explains some possible implementations, while others not mentioned can be referred to in the content above, which will not be repeated here.

In some possible implementations, the first sequence is processed by repeating or up-sampling the first sequence.

In some possible implementations, the first sequence is a coded bit sequence.

It may be noted that, in conjunction with the content in “\textcircled{2} First Sequence” in “Implementation 1”, the coding can include channel coding, or include channel coding plus CRC coding.

In some possible implementations, the method further includes: modulating the second sequence to output a third sequence; and pre-coding the third sequence to output the fourth sequence.

It may be noted that, in conjunction with the content in “\textcircled{4} Subsequent Processing on Second Sequence” in “Implementation 1”, in the disclosure, the second sequence output after being processed is modulated, thereby converting the second sequence into “time-domain” symbols or modulation symbols, and then converting the “time-domain” symbols or modulation symbols into “frequency-domain” symbols through pre-coding, and mapping the “frequency-domain” symbols onto subcarriers for frequency division multiplexing with other OFDM-based signals/channels.

In some possible implementations, the method further includes scrambling the second sequence to output a fifth sequence.

It may be noted that, in conjunction with the content in “\textcircled{2} Subsequent Processing on Second Sequence” in “Implementation 2” mentioned above, in the disclosure, the inter-cell interference randomization can be ensured to the greatest extent by scrambling the second sequence to alleviate inter-cell interference.

In some possible implementations, a scrambling sequence or an initial value of a scrambling sequence generator contains a cell identity.

It may be noted that, in conjunction with the content in “\textcircled{2} Subsequent Processing on Second Sequence” in “Implementation 2” mentioned above, the fifth sequence outputted after scrambling in the disclosure may carry the cell identity, allowing the wake-up signal to carry the cell identity.

In some possible implementations, the method further includes modulating the fifth sequence to output a sixth sequence; and pre-coding the sixth sequence to output a seventh sequence.

It may be noted that, in conjunction with the content in “\textcircled{2} Subsequent Processing on Second Sequence” in “Implementation 2”, in the disclosure, the fifth sequence outputted after scrambling can be modulated, thus converting the fifth sequence into “time-domain” symbols or modulation symbols, and then converting the “time-domain” symbols or modulation symbols into “frequency-domain” symbols through pre-coding, and mapping the “frequency-domain” symbols to subcarriers for frequency division multiplexing with other OFDM-based signals/channels.

In some possible implementations, pre-coding includes DFT pre-coding or pseudo-inverse-based pre-coding.

It may be noted that, in conjunction with the content in “Implementation 1” and “Implementation 2”, DFT pre-coding or pseudo-inverse-based pre-coding enables the low-power receiver of the terminal device to detect OOK symbols through IDFT decoding or without decoding, thereby reducing the power consumption of the low-power receiver.

### 4. Another Exemplary Illustration of Wake-up Signal Processing Method

### 1). Description

In conjunction with the content of “Implementation 3” and “Implementation 4” mentioned above, the following provides an exemplary introduction of another wake-up signal processing method in embodiments of the disclosure. It may be noted that this method can be applied to a network device. The network device can be a chip, chip module, or communication module, etc., which is not specifically limited herein.

As illustrated in FIG. 3, which is a flow schematic diagram of another wake-up signal processing method in embodiments of the disclosure, the method specifically includes the following.

S310, a first sequence is modulated and an eighth sequence is output.

S320, the eighth sequence is Pre-coded and a ninth sequence is output.

It may be noted that terms such as “first sequence”, “modulate”, “pre-coding”, “eighth sequence”, and “ninth sequence” are detailed in the above content and will not be elaborated here.

As can be seen, in the disclosure, the first sequence is converted into “time-domain” symbols or modulation symbols through modulation, and then the “time-domain” symbols or modulation symbols are converted into “frequency-domain” symbols through pre-coding, which are then mapped onto subcarriers for frequency division multiplexing with other OFDM-based signals/channels. In addition, the sequence length of the first sequence is increased through modulation and/or pre-coding, that is, the number of bits in the first sequence is increased, thus achieving the process on the wake-up signal, in order to minimize the correlation/association among various first sequences and to ensure the inter-cell interference randomization.

### 2) Some Possible Implementations

In conjunction with the above content, the following illustrates some possible implementations, while reference of others not mentioned can be made to the content above, which will not be repeated here.

In some possible implementations, the first sequence may be a coded bit sequence.

It may be noted that, in conjunction with the content in “2 First Sequence” in “Implementation 1”, the coding can include channel coding, or the coding can include channel coding plus CRC coding.

In some possible implementations, the pre-coding may include DFT pre-coding or pseudo-inverse-based pre-coding.

It may be noted that, in conjunction with the content in “Implementation 3” above, through DFT pre-coding or pseudo-inverse-based pre-coding, the low-power receiver of the terminal device can detect OOK symbols by IDFT decoding or without decoding, thus reducing the power consumption of the low-power receiver.

In some possible implementations, the method further includes scrambling the ninth sequence to output a tenth sequence.

It may be noted that, in conjunction with the content in “Implementation 4” regarding “\textcircled{2} Subsequent Processing on Ninth Sequence”, in the disclosure, the inter-cell interference randomization can be ensured to the greatest extent by scrambling the ninth sequence, thereby mitigating inter-cell interference.

In some possible implementations, a scrambling sequence or an initial value of a scrambling sequence generator contains a cell identity.

It may be noted that, in conjunction with the content in “2 Subsequent Processing on Ninth Sequence” in “Implementation 4” mentioned above, the fifth sequence output after scrambling in the disclosure can carry the cell identity, allowing the wake-up signal to carry the cell identity.

### 5. Another Exemplary Illustration of Wake-Up Signal Processing Method

### 1). Description

In conjunction with the content of “Implementation 5”, the following provides an exemplary introduction of another wake-up signal processing method in embodiments of the disclosure. It may be noted that this method can be applied to a network device. The network device can be a chip, chip module, or communication module, etc., which is not specifically limited herein.

As illustrated in FIG. 4, which is a flowchart of another wake-up signal processing method in embodiments of the disclosure, the method specifically includes the following.

S410, a first sequence is processed for a first time and an eleventh sequence is output.

It may be noted that terms such as “first sequence”, “repeating for a first time”, “up-sampling for a first time”, and “eleventh sequence”, etc., are detailed in the above content and will not be repeated here.

As can be seen, in the disclosure, through the processing for the first time, the sequence length of the first sequence is increased, that is, the number of bits of the first sequence is increased, thus achieving the processing on the wake-up signal, in order to minimize the correlation/relevance among various first sequences and ensuring inter-cell interference randomization.

### 2) Some Possible Implementations

In conjunction with the above content, the following illustrated some possible implementations, while reference of others not mentioned can be made to the content above, which will not be repeated here.

In some possible implementations, the first sequence is processed for the first time by repeating or up-sampling the first sequence for the first time.

In some possible implementations, the first sequence is a coded bit sequence.

It may be noted that, in conjunction with the content in “\textcircled{2} First Sequence” in “Implementation 1”, the coding can include channel coding, or it can include channel coding plus CRC coding.

In some possible implementations, the method further includes scrambling the eleventh sequence to output a twelfth sequence.

It may be noted that, in conjunction with the content in “\textcircled{2} Subsequent Processing on Eleventh Sequence” in “Implementation 5”, in the disclosure, the inter-cell interference randomization can be ensured to the greatest extent by scrambling the eleventh sequence, thereby reducing inter-cell interference.

In some possible implementations, a scrambling sequence or an initial value of a scrambling sequence generator contains a cell identity.

It may be noted that, in conjunction with the content in “\textcircled{2} Subsequent processing on Eleventh Sequence” in “Implementation 5”, the twelfth sequence output after scrambling in the disclosure can carry the cell identity, allowing the wake-up signal to carry the cell identity.

In some possible implementations, the method further includes processing the twelfth sequence for a second time to output a thirteenth sequence.

It may be noted that, in conjunction with the content in “\textcircled{2} Subsequent processing on Eleventh Sequence” in “Implementation 5”, in the disclosure, the sequence length of the twelfth sequence can be increased through processing for the second time (which can be understood as further increasing the sequence length of the first sequence), that is, the number of bits in the twelfth sequence is increased, thereby guaranteeing the descrambling of the low-power receiver of the terminal device, while minimizing the correlation/association among various first sequences and ensuring the inter-cell interference randomization.

In some possible implementations, processing the twelfth sequence for the second time includes repeating or up-sampling the twelfth sequence for the second time.

In some possible implementations, the method further includes modulating the thirteenth sequence to output a fourteenth sequence; and pre-coding the fourteenth sequence to output a fifteenth sequence.

It may be noted that, in conjunction with the content in “\textcircled{2} Subsequent Processing on Eleventh Sequence” in “Implementation 5”, in the disclosure, the thirteenth sequence output after repeating for the second time or up-sampling for the second time is modulated, thereby converting the thirteenth sequence into “time-domain” symbols or modulation symbols, and then converting the “time-domain” symbols or modulation symbols into “frequency-domain” symbols through pre-coding, which are then mapped to subcarriers for frequency division multiplexing with other OFDM-based signals/channels.

In some possible implementations, pre-coding may include DFT pre-coding or pseudo-inverse-based pre-coding.

It may be noted that, in conjunction with the content in “\textcircled{2} Subsequent Processing on Eleventh Sequence” in “Implementation 5”, in the disclosure, DFT pre-coding or pseudo-inverse-based pre-coding enables the low-power receiver of the terminal device to detect OOK symbols through IDFT decoding or without decoding, thereby reducing the power consumption of the low-power receiver.

### V. EXEMPLARY ILLUSTRATION OF WAKE-SIGNAL PROCESSING APPARATUS

### 1. Description

The solutions in embodiments of the disclosure are introduced mainly from the perspective of the method. It may be understood that, in order to realize the foregoing functions, the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods may not be regarded as lying beyond the scope of the disclosure.

In embodiments of the disclosure, division of functional units of the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It may be noted that, the division of units in embodiments of the disclosure is illustrative and is only a division of logical functions, and other methods of division may also available in practice.

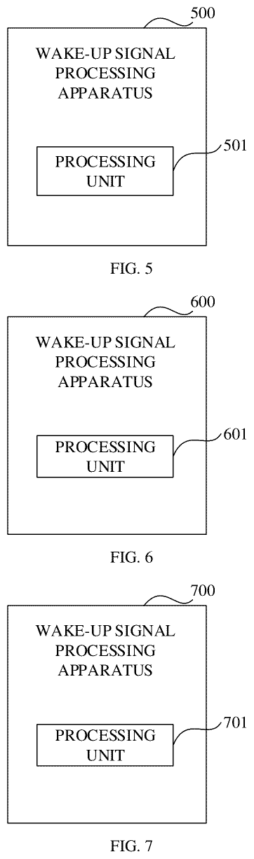

If an integrated unit is adopted, FIG. 5 is a functional block diagram of a wake-up signal processing apparatus in embodiments of the disclosure. The wake-up signal processing apparatus 500 includes a processing unit 501.

In some possible implementations, the processing unit 501 may be a module unit for processing signals, data, information, sequence, and the like, which is not specifically limited herein.

In some possible implementations, the processing unit 501 may be a processor or a controller, such as a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the wake-up signal processing apparatus 500 further includes a storage unit. The storage unit is configured to store computer program codes or instructions executable by the wake-up signal processing apparatus 500. The storage unit may be a memory.

In some possible implementations, the wake-up signal processing apparatus 500 may be a chip or chip module.

In some possible implementations, the processing unit 501 may be integrated into another unit.

For example, the processing unit 501 may be integrated into a communication unit.

It should be noted that the communication unit may be a communication interface, a transceiver, a transceiver circuit, and the like.

In some possible implementations, the processing unit 501 is configured to perform any one of the steps implemented by the network device/chip/chip module/transmitter of the network device in the foregoing method embodiments. Detailed elaboration will be given below.

During implementation, the processing unit 501 is configured to perform any step in the foregoing method embodiments. When performing an action such as sending, another unit may be selectively invoked to complete a corresponding operation. Detailed elaboration will be given below.

The processing unit 501 is configured to process a first sequence to output a second sequence.

It can be seen that in the disclosure, the length of the first sequence is increased through processing, that is, the number of bits in the first sequence is increased, thus achieving the processing on the wake-up signal, so as to minimize the correlation/association among various first sequences and ensure inter-cell interference randomization.

It may be noted that, for specific implementation of each operation in the embodiment illustrated in FIG. 5, reference may be made to the description in the foregoing method embodiments, which will not be described in detail herein again.

### 2) Some Possible Implementations

The following describes some possible implementations. Reference of some specific descriptions can be made to above, which will not be repeated here.

In some possible implementations, in terms of processing the first sequence, the processing unit 501 is configured to repeat or up-sample the first sequence.

In some possible implementations, the first sequence is a coded bit sequence.

It may be noted that, in conjunction with the content in “2) First Sequence” in “Implementation 1”, the coding can include channel coding, or include channel coding plus CRC coding.

In some possible implementations, the wake-up signal processing apparatus 500 further includes a modulating and pre-coding unit. The modulating and pre-coding unit is configured to modulate the second sequence to output a third sequence; and pre-code the third sequence to output a fourth sequence.

It may be noted that, in conjunction with the content in “\textcircled{4} Subsequent Processing on Second Sequence” in “Implementation 1”, in the disclosure, the second sequence output after being processed is modulated, thereby converting the second sequence into “time-domain” symbols or modulation symbols, and then converting the “time-domain” symbols or modulation symbols into “frequency-domain” symbols through pre-coding, and mapping the “frequency-domain” symbols onto subcarriers for frequency division multiplexing with other OFDM-based signals/channels.

In some possible implementations, the wake-up signal processing apparatus 500 further includes a scrambling unit. The scrambling unit is configured to scramble the second sequence to output a fifth sequence.

It may be noted that, in conjunction with the content in “\textcircled{2} Subsequent Processing on Second Sequence” in “Implementation 2” mentioned above, in the disclosure, the inter-cell interference randomization can be ensured to the greatest extent by scrambling the second sequence to alleviate inter-cell interference.

In some possible implementations, a scrambling sequence or an initial value of a scrambling sequence generator contains a cell identity.

It may be noted that, in conjunction with the content in “\textcircled{2} Subsequent Processing on Second Sequence” in “Implementation 2” mentioned above, the fifth sequence outputted after scrambling in the disclosure may carry the cell identity, allowing the wake-up signal to carry the cell identity.

In some possible implementations, the wake-up signal processing apparatus 500 further includes a modulating and pre-coding unit. The modulating and pre-coding unit is configured to modulate the fifth sequence to output a sixth sequence; and pre-code the sixth sequence to output a seventh sequence.

It may be noted that, in conjunction with the content in “\textcircled{2} Subsequent Processing on Second Sequence” in “Implementation 2” mentioned above, in the disclosure, the fifth sequence outputted after scrambling can be modulated, thus converting the fifth sequence into “time-domain” symbols or modulation symbols, and then converting the “time-domain” symbols or modulation symbols into “frequency-domain” symbols through pre-coding, and mapping the “frequency-domain” symbols to subcarriers for frequency division multiplexing with other OFDM-based signals/channels.

In some possible implementations, pre-coding includes DFT pre-coding or pseudo-inverse-based pre-coding.

It may be noted that, in conjunction with the content in “Implementation 1” and “Implementation 2” mentioned above, DFT pre-coding or pseudo-inverse-based pre-coding enables the low-power receiver of the terminal device to detect OOK symbols through IDFT decoding or without decoding, thereby reducing the power consumption of the low-power receiver.

### VI. ANOTHER EXEMPLARY ILLUSTRATION OF WAKE-UP SIGNAL PROCESSING APPARATUS

If an integrated unit is adopted, FIG. 6 is a functional block diagram of another wake-up signal processing apparatus in embodiments of the disclosure. The wake-up signal processing apparatus 600 includes a processing unit 601.

In some possible implementations, the processing unit 601 may be a module unit for processing signals, data, information, sequence, and the like, which is not specifically limited herein.

In some possible implementations, the processing unit 601 may be a processor or a controller, such as a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the wake-up signal processing apparatus 600 further includes a storage unit. The storage unit is configured to store computer program codes or instructions executable by the wake-up signal processing apparatus 600. The storage unit may be a memory.

In some possible implementations, the wake-up signal processing apparatus 600 may be a chip or chip module.

In some possible implementations, the processing unit 601 may be integrated into another unit.

For example, the processing unit 601 may be integrated into a communication unit. It should be noted that the communication unit may be a communication interface, a transceiver, a transceiver circuit, and the like.

In some possible implementations, the processing unit 601 is configured to perform any one of the steps implemented by the network device/chip/chip module/transmitter of the network device in the foregoing method embodiments. Detailed elaboration will be given below.

During implementation, the processing unit 601 is configured to perform any step in the foregoing method embodiments. When performing an action such as sending, another unit may be selectively invoked to complete a corresponding operation. Detailed elaboration will be given below.

The processing unit 601 is configured to modulate a first sequence to output an eighth sequence; and pre-code the eighth sequence to output a ninth sequence.

As can be seen, in the disclosure, the first sequence is converted into “time-domain” symbols or modulation symbols through modulation, and then the “time-domain” symbols or modulation symbols are converted into “frequency-domain” symbols through pre-coding, which are then mapped onto subcarriers for frequency division multiplexing with other OFDM-based signals/channels. In addition, the sequence length of the first sequence is increased through modulation and/or pre-coding, that is, the number of bits in the first sequence is increased, thus achieving the process on the wake-up signal, in order to minimize the correlation/association among various first sequences and to ensure the inter-cell interference randomization.

It may be noted that, for specific implementation of each operation in the embodiment illustrated in FIG. 6, reference may be made to the description in the foregoing method embodiments, which will not be described in detail herein again.

### 2) Some Possible Implementations

The following describes some possible implementations. Reference of some specific descriptions can be made to above, which will not be repeated here.

In some possible implementations, the first sequence may be a coded bit sequence.

It may be noted that, in conjunction with the content in “(2) First Sequence” in “Implementation 1” mentioned above, the coding can include channel coding, or the coding can include channel coding plus CRC coding.

In some possible implementations, the pre-coding may include DFT pre-coding or pseudo-inverse-based pre-coding.

It may be noted that, in conjunction with the content in “Implementation 3” above, through DFT pre-coding or pseudo-inverse-based pre-coding, the low-power receiver of the terminal device can detect OOK symbols by IDFT decoding or without decoding, thus reducing the power consumption of the low-power receiver.

In some possible implementations, the wake-up signal processing apparatus 600 further includes a scrambling unit configured to scramble the ninth sequence to output a tenth sequence.

It may be noted that, in conjunction with the content in “Implementation 4” regarding “\textcircled{2} Subsequent Processing on Ninth Sequence” mentioned above, in the disclosure, the inter-cell interference randomization can be ensured to the greatest extent by scrambling the ninth sequence, thereby mitigating inter-cell interference.

In some possible implementations, a scrambling sequence or an initial value of a scrambling sequence generator contains a cell identity.

It may be noted that, in conjunction with the content in “\textcircled{2} Subsequent Processing on Ninth Sequence” in “Implementation 4” mentioned above, the fifth sequence output after scrambling in the disclosure can carry the cell identity, allowing the wake-up signal to carry the cell identity.

### VII. ANOTHER EXEMPLARY ILLUSTRATION OF WAKE-UP SIGNAL PROCESSING APPARATUS

If an integrated unit is adopted, FIG. 7 is a functional block diagram of another wake-up signal processing apparatus in embodiments of the disclosure. The wake-up signal processing apparatus 700 includes a processing unit 701.

In some possible implementations, the processing unit 701 may be a module unit for processing signals, data, information, sequence, and the like, which is not specifically limited herein.

In some possible implementations, the processing unit 701 may be a processor or a controller, such as a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure may be implemented or executed. The processing unit may also be a combination for implementing computing functions, for example, one or more microprocessors, a combination of DSP and microprocessor, or the like.

In some possible implementations, the wake-up signal processing apparatus 700 further includes a storage unit. The storage unit is configured to store computer program codes or instructions executable by the wake-up signal processing apparatus 700. The storage unit may be a memory.

In some possible implementations, the wake-up signal processing apparatus 700 may be a chip or chip module.

In some possible implementations, the processing unit 701 may be integrated into another unit.

For example, the processing unit 701 may be integrated into a communication unit. It should be noted that the communication unit may be a communication interface, a transceiver, a transceiver circuit, and the like.

In some possible implementations, the processing unit 701 is configured to perform any one of the steps implemented by the network device/chip/chip module/transmitter of the network device in the foregoing method embodiments. Detailed elaboration will be given below.

During implementation, the processing unit 701 is configured to perform any step in the foregoing method embodiments. When performing an action such as sending, another unit may be selectively invoked to complete a corresponding operation. Detailed elaboration will be given below.

The processing unit 701 is configured to process a first sequence for a first time to output an eleventh sequence

As can be seen, in the disclosure, through the processing for the first time, the sequence length of the first sequence is increased, that is, the number of bits of the first sequence is increased, thus achieving the processing on the wake-up signal, in order to minimize the correlation/relevance among various first sequences and ensuring inter-cell interference randomization.

It may be noted that, for specific implementation of each operation in the embodiment illustrated in FIG. 7, reference may be made to the description in the foregoing method embodiments, which will not be described in detail herein again.

### 2) Some Possible Implementations

The following describes some possible implementations. Reference of some specific descriptions can be made to above, which will not be repeated here.

In some possible implementations, in terms of processing the first sequence for the first time, the processing unit 701 is configured to repeat or up-sample the first sequence for the first time.

In some possible implementations, the first sequence is a coded bit sequence.

It may be noted that, in conjunction with the content in “\textcircled{2} First Sequence” in “Implementation 1” mentioned above, the coding can include channel coding, or it can include channel coding plus CRC coding.

In some possible implementations, the wake-up signal processing apparatus 700 further includes a scrambling unit configured to scramble the eleventh sequence to output a twelfth sequence.

It may be noted that, in conjunction with the content in “\textcircled{2} Subsequent Processing on Eleventh Sequence” in “Implementation 5” mentioned above, in the disclosure, the inter-cell interference randomization can be ensured to the greatest extent by scrambling the eleventh sequence, thereby reducing inter-cell interference.

In some possible implementations, a scrambling sequence or an initial value of a scrambling sequence generator contains a cell identity.

It may be noted that, in conjunction with the content in “\textcircled{2} Subsequent processing on Eleventh Sequence” in “Implementation 5” mentioned above, the twelfth sequence output after scrambling in the disclosure can carry the cell identity, allowing the wake-up signal to carry the cell identity.

In some possible implementations, the processing unit 701 is configured to process the twelfth sequence for a second time to output a thirteenth sequence.

It may be noted that, in conjunction with the content in “\textcircled{2} Subsequent processing on Eleventh Sequence” in “Implementation 5” mentioned above, in the disclosure, the sequence length of the twelfth sequence can be increased through processing for the second time (which can be understood as further increasing the sequence length of the first sequence), that is, the number of bits in the twelfth sequence is increased, thereby guaranteeing the descrambling of the low-power receiver of the terminal device, while minimizing the correlation/association among various first sequences and ensuring the inter-cell interference randomization.

In some possible implementations, in terms of processing the twelfth sequence for the second time, the processing unit 701 is configured to repeat or up-sample the twelfth sequence for the second time.

In some possible implementations, the wake-up signal processing apparatus 700 further includes a modulating and pre-coding unit. The modulating and pre-coding unit is configured to modulate the thirteenth sequence to output a fourteenth sequence; and pre-code the fourteenth sequence to output a fifteenth sequence.

It may be noted that, in conjunction with the content in “\textcircled{2} Subsequent Processing on Eleventh Sequence” in “Implementation 5”, in the disclosure, the thirteenth sequence output after repeating for the second time or up-sampling for the second time is modulated, thereby converting the thirteenth sequence into “time-domain” symbols or modulation symbols, and then converting the “time-domain” symbols or modulation symbols into “frequency-domain” symbols through pre-coding, which are then mapped to subcarriers for frequency division multiplexing with other OFDM-based signals/channels.

In some possible implementations, pre-coding may include DFT pre-coding or pseudo-inverse-based pre-coding.

It may be noted that, in conjunction with the content in “\textcircled{2} Subsequent Processing on Eleventh Sequence” in “Implementation 5”, in the disclosure, DFT pre-coding or pseudo-inverse-based pre-coding enables the low-power receiver of the terminal device to detect OOK symbols through IDFT decoding or without decoding, thereby reducing the power consumption of the low-power receiver.

### VIII. EXEMPLARY ILLUSTRATION OF NETWORK DEVICE

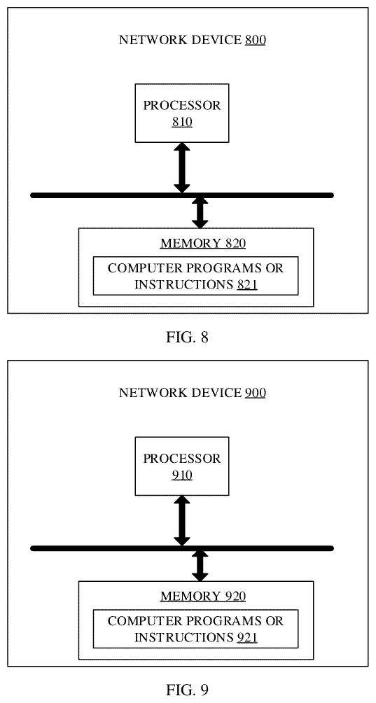

Referring to FIG. 8, FIG. 8 is a schematic structural diagram of a network device in embodiments of the disclosure. The network device 800 includes a processor 810, a memory 820, and a communication bus configured to connect the processor 810 and the memory 820.

In some possible implementations, the memory 820 includes, but is not limited to, a random access memory (RAM), a read-only memory (ROM), an erasable programmable read-only memory (EPROM), or a compact disc read-only memory (CD-ROM). The memory 820 is configured to store related instructions and data.

In some possible implementations, the network device 800 further includes a communication interface for receiving and sending data.

In some possible implementations, the processor 810 may be one or more CPUs. When the processor 810 is one CPU, the CPU may be a single-core CPU, or may be a multi-core CPU.

In some possible implementations, the processor 810 may be a baseband chip, a chip, a CPU, a general-purpose processor, a DSP, an application-specific integrated circuit (ASIC), a field programmable gate array (FPGA), or other programmable logic devices, transistor logic devices, hardware components, or any combination thereof.

In some possible implementations, the processor 810 in the network device 800 is configured to execute computer programs or instructions 821 stored in the memory 820 to perform the following operations: processing a first sequence to output a second sequence.

It can be seen that in the present disclosure, a sequence length of the first sequence is increased through processing, that is, the number of bits in the first sequence is increased, to achieve processing on the wake-up signal, so as to minimize the correlation/association among various first sequences and ensure inter-cell interference randomization.

It should be noted that, for the implementation of each operation, reference may be made to the corresponding elaboration in the foregoing method embodiments, and the network device 800 may be configured to perform the foregoing method embodiments of the disclosure, which is not described again herein.

### IX. EXEMPLARY ILLUSTRATION OF ANOTHER NETWORK DEVICE

Referring to FIG. 9, FIG. 9 is a schematic structural diagram of a network device in embodiments of the disclosure. The network device 900 includes a processor 910, a memory 920, and a communication bus configured to connect the processor 910 and the memory 920.

In some possible implementations, the memory 920 includes, but is not limited to, an RAM, an ROM, an EPROM, or a CD-ROM. The memory 920 is configured to store instructions and data executable by the network device 900.

In some possible implementations, the network device 900 further includes a communication interface for receiving and sending data.

In some possible implementations, the processor 910 may be one or more CPUs. When the processor 910 is one CPU, the CPU may be a single-core CPU, or may be a multi-core CPU.

In some possible implementations, the processor 910 may be a baseband chip, a chip, a CPU, a general-purpose processor, a DSP, an ASIC, an FPGA, or other programmable logic devices, transistor logic devices, hardware components, or any combination thereof.

In specific implementations, the processor 910 in the network device 900 is configured to execute computer programs or instructions 921 stored in the memory 920 to perform the following operations: modulating a first sequence to output an eighth sequence; and pre-coding the eighth sequence to output a ninth sequence.

As can be seen, in the disclosure, the first sequence is converted into “time-domain” symbols or modulation symbols through modulation, and then the “time-domain” symbols or modulation symbols are converted into “frequency-domain” symbols through pre-coding, which are then mapped onto subcarriers for frequency division multiplexing with other OFDM-based signals/channels. In addition, the sequence length of the first sequence is increased through modulation and/or pre-coding, that is, the number of bits in the first sequence is increased, thus achieving the process on the wake-up signal, in order to minimize the correlation/association among various first sequences and to ensure the inter-cell interference randomization.

It should be noted that, for the implementation of each operation, reference may be made to the corresponding elaboration in the foregoing method embodiments, and the network device 900 may be configured to perform the foregoing method embodiments of the disclosure, which is not described again herein.

### X. EXEMPLARY ILLUSTRATION OF ANOTHER NETWORK DEVICE

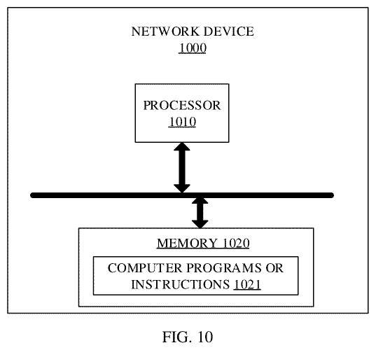

Referring to FIG. 10, FIG. 10 is a schematic structural diagram of a network device in embodiments of the disclosure. The network device 1000 includes a processor 1010, a memory 1020, and a communication bus configured to connect the processor 1010 and the memory 1020.

In some possible implementations, the memory 1020 includes, but is not limited to, an RAM, an ROM, an EPROM, or a CD-ROM. The memory 1020 is configured to store instructions and data executable by the terminal device 1000.

In some possible implementations, the network device 1000 further includes a communication interface for receiving and sending data.

In some possible implementations, the processor 1010 may be one or more CPUs. When the processor 1010 is one CPU, the CPU may be a single-core CPU, or may be a multi-core CPU.

In some possible implementations, the processor 1010 may be a baseband chip, a chip, a CPU, a general-purpose processor, a DSP, an ASIC, an FPGA, or other programmable logic devices, transistor logic devices, hardware components, or any combination thereof.

In specific implementations, the processor 1010 in the network device 1000 is configured to execute computer programs or instructions 1021 stored in the memory 1020 to perform the following operations: processing a first sequence for a first time to output an eleventh sequence.

It can be seen that, in the present disclosure, through the processing for the first time, the sequence length of the first sequence is increased, that is, the number of bits of the first sequence is increased, to achieve processing on the wake-up signal, so as to minimize the correlation/relevance among various first sequences and to ensure inter-cell interference randomization.

It should be noted that, for the implementation of each operation, reference may be made to the corresponding elaboration in the foregoing method embodiments, and the network device 1000 may be configured to perform the foregoing method embodiments of the disclosure, which is not described again herein.

### XI. OTHER RELATED EXEMPLARY ILLUSTRATIONS

In some possible implementations, the above method embodiments may be applied to or in a network device. That is, the execution entity of the above method embodiments may be a network device, a chip, a chip module, a module, or a transmitter of a network device etc., which is not limited herein.

A chip is further provided in embodiments of the disclosure. The chip includes a processor, a memory, and computer programs or instructions stored in the memory. The processor is configured to execute the computer programs or instructions to perform the operations of the above method embodiments.

A chip module is further provided in embodiments of the disclosure. The chip module includes a transceiver assembly and a chip. The chip includes a processor, a memory, and computer programs or instructions stored in the memory. The processor is configured to execute the computer programs or instructions to perform the operations of the above method embodiments.

A non-transitory computer-readable storage medium is further provided in embodiments of the disclosure. The non-transitory computer-readable storage medium is configured to store computer programs or instructions which, when executed, are operable to implement the operations of the above method embodiments.

A computer program product is further provided in embodiments of the disclosure. The computer program product includes computer programs or instructions which, when executed, are operable to implement the operations of the above method embodiments.

A communication system is further provided in embodiments of the disclosure. The communication system includes the terminal device and the network device above.

It may be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference can be made to related elaborations in other embodiments.

The operations of the method or algorithm described in embodiments of the disclosure may be implemented by means of hardware, or may be implemented by executing software instructions by a processor. The software instructions can be implemented by corresponding software modules, which can be stored in a RAM, a flash memory, a ROM, an EPROM, an electrically EPROM (EEPROM), registers, hard disk, mobile hard disk, CD-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in a terminal device or a management device. The processor and the storage medium may also be present as discrete components in the terminal device or the management device.

Those skilled in the art will appreciate that, all or part of functions described in embodiments of the disclosure can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc.

Each module/unit in various devices or products described in the foregoing embodiments may be a software module/unit or a hardware module/unit, or some may be a software module/unit and some may be a hardware module/unit. For example, with regard to various devices or products applied to or integrated into a chip, various modules/units included therein may all be realized by means of hardware such as a circuit. Alternatively, at least some of the modules/units may be realized by means of a software program run on a processor integrated into the chip, and the rest (if any) modules/units may be implemented by means of hardware such as a circuit. With regard to various devices or products applied to or integrated into a chip module, various modules/units included therein may all be realized by means of hardware such as a circuit, and different modules/units can be located in the same component (such as chip, circuit module, etc.) or in different components of the chip module. Alternatively, at least some of the modules/units may be realized by means of a software program run on a processor integrated into the chip module, and the rest (if any) modules/units may be implemented by means of hardware such as a circuit. With regard to various devices or products applied to or integrated into a terminal device, various modules/units included therein may all be realized by means of hardware such as a circuit, and different modules/units can be located in the same component (such as chip, circuit module, etc.) or in different components of the terminal device. Alternatively, at least some of the modules/units may be realized by means of a software program run on a processor integrated into the chip module, and the rest (if any) modules/units may be implemented by means of hardware such as a circuit.

The objectives, technical solutions, and advantages of embodiments of the disclosure are described in detail in the foregoing implementations. It may be appreciated that, the foregoing elaborations are merely some implementations of embodiments of the disclosure, but are not intended to limit the protection scope of embodiments of the disclosure. Any modifications, equivalent replacements, improvements, and the like made based on the technical solutions of embodiments of the disclosure shall all fall within the protection scope of embodiments of the disclosure.

1. A wake-up signal processing method, comprising:
processing a first sequence to output a second sequence, wherein a length of the second sequence is greater than a length of the first sequence.

2. The method of claim 1, wherein processing the first sequence comprises:
repeating or up-sampling the first sequence.

3. The method of claim 1, wherein the first sequence is a coded bit sequence.

4. The method of claim 1, further comprising:
modulating the second sequence to output a third sequence; and
precoding the third sequence to output a fourth sequence.

5. The method of claim 1, further comprising:
scrambling the second sequence to output a fifth sequence.

6. The method of claim 5, wherein a scrambling sequence or an initial value of a scrambling sequence generator contains a cell identity.

7. The method of claim 5, further comprising:
modulating the fifth sequence to output a sixth sequence; and
pre-coding the sixth sequence to output a seventh sequence.

8. The method of claim 7, wherein the pre-coding includes discrete Fourier transform (DFT) pre-coding or pseudo-inverse-based pre-coding.

9. A wake-up signal processing method, comprising:
modulating a first sequence to output an eighth sequence; and
pre-coding the eighth sequence to output a ninth sequence.

10. The method of claim 9, wherein the first sequence is a coded bit sequence.

11. (canceled)

12. The method of claim 9, further comprising:
scrambling the ninth sequence to output a tenth sequence.

13. The method of claim 12, wherein a scrambling sequence or an initial value of a scrambling sequence generator contains a cell identity.

14. A wake-up signal processing method, comprising:
processing a first sequence for a first time to output an eleventh sequence, wherein a length of the eleventh sequence is greater than a length of the first sequence.

15. The method of claim 14, wherein processing the first sequence for the first time comprises:
repeating or up-sampling the first sequence for the first time.

16. The method of claim 14, wherein the first sequence is a coded bit sequence.

17. The method of claim 14, further comprising:
scrambling the eleventh sequence to output a twelfth sequence.

18. The method of claim 17, wherein a scrambling sequence or an initial value of a scrambling sequence generator contains a cell identity.

19. The method of claim 17, further comprising:
processing the twelfth sequence for a second time to output a thirteenth sequence, wherein a length of the thirteenth sequence is greater than a length of the twelfth sequence.

20. The method of claim 19, wherein processing the twelfth sequence for the second time comprises:
repeating or up-sampling the twelfth sequence for the second time.

21. The method of claim 19, further comprising:
modulating the thirteenth sequence to output a fourteenth sequence; and
pre-coding the fourteenth sequence to output a fifteenth sequence.

22-28. (canceled)
